(19) United States
(12) Patent Application Publication
(10) Pub. No.: US 2023/0102854 A1
(43) Pub. Date: Mar. 30, 2023

(54) AIR IONIZATION SYSTEM FOR A TRANSIT VEHICLE

(71) Applicant: Jackson Control Co., Inc., Indianapolis, IN (US)

(72) Inventor: Daniel J. Evans, Crown Point, IN (US)

(21) Appl. No.: 17/933,351

(22) Filed: Sep. 19, 2022

Related U.S. Application Data
(60) Provisional application No. 63/248,026, filed on Sep. 24, 2021.

(51) Int. Cl. B03C 3/86; B60H 3/00; B03C 3/68; B03C 3/011; B03C 3/36

(52) U.S. Cl. CPC B03C 3/86; B60H 3/0078; B03C 3/68; B03C 3/011; B03C 3/368; B03C 2201/24; B03C 2201/30

(57) ABSTRACT

An air ionization system is provided for creating an ionized airflow within a transit vehicle. The air ionization system includes a block having electronic control circuitry therein, air ionizing electrodes, and wiring electrically coupling the air ionizing electrodes to the electronic control circuitry. The air ionizing electrodes are mounted remote to the block in the transit vehicle and are mounted within an air distribution unit of the transit vehicle.

### CROSS-REFERENCE TO RELATED APPLICATION(S)

This application claims priority to U.S. provisional application Ser. No. 63/248,026, filed on Sep. 24, 2021, the contents of which are incorporated herein in its entirety.

### FIELD OF THE DISCLOSURE

The present disclosure relates to an air ionization system for a transit vehicle.

### BACKGROUND

U.S. Pat. No. 7,177,133, which is herein incorporated by reference, discloses an example form of an ion generator, although it will be understood that various different ion generators may be adapted for use in connection with the present disclosure. Prior art ion generators, such as that disclosed in U.S. Pat. No. 7,177,133 includes a block in which the electronic control circuitry is housed, and a pair of air ionizing electrodes mounted in insulators extending from the block. The air ionizing electrodes are mounted within screens and are connected to high voltage terminals of voltage stabilizers within the block. The voltage stabilizers generate high voltage, which is applied to the air ionizing electrodes via the control circuitry to create positive ion generation and negative ion generation. Ions are expelled to the environment by the external electric field generated between the screens.

U.S. Pat. No. 8,564,924, which is herein incorporated by reference, discloses a system and method of treating air. Bipolar ionization is delivered to an airflow within a conduit from a tubeless ion generator. The ionized airflow may be delivered to a conditioned airspace by an HVAC system. In alternate applications, the airflow delivers ionized combustion air to an engine. A mounting assembly is provided for positioning one or more ion generators into an airflow. The ion generators includes a block and at least one pair of air ionizing needlepoint electrodes for positive ion generation and for negative ion generation. The air ionizing needlepoint electrodes may be needles of stainless steel, carbon fiber, tungsten, steel or other metal. Onboard control circuitry is provided in the block.

One issue that arises with the prior art systems is positioning the block with its attached electrodes within the air stream. It can be unwieldy for the installer to install while ensuring the proper placement of the electrodes within the air stream. A solution to this issue is desirable.

### BRIEF DESCRIPTION OF THE DRAWINGS

The organization and manner of the structure and operation of the disclosed embodiments, together with further objects and advantages thereof, may best be understood by reference to the following description, taken in connection with the accompanying drawings, which are not necessarily drawn to scale, wherein like reference numerals identify like elements in which:

FIG. 1 depicts a perspective view of an example transit vehicle having an air ionization system;

FIG. 2 depicts a perspective view of a first embodiment of the air ionization system shown separated from the transit vehicle;

FIG. 3 depicts a perspective view of an air distribution unit in which the air ionization system of FIG. 2 is provided; and

FIG. 4 depicts a perspective view of a second embodiment of the air ionization system for use on the transit vehicle and shown on the air distribution unit.

### DETAILED DESCRIPTION

While the disclosure may be susceptible to embodiment in different forms, there is shown in the drawings, and herein will be described in detail, specific embodiments with the understanding that the present disclosure is to be considered an exemplification of the principles of the disclosure, and is not intended to limit the disclosure to that as illustrated and described herein. Therefore, unless otherwise noted, features disclosed herein may be combined to form additional combinations that were not otherwise shown for purposes of brevity. It will be further appreciated that in some embodiments, one or more elements illustrated by way of example in a drawing(s) may be eliminated and/or substituted with alternative elements within the scope of the disclosure.

Directional terms such as front, rear, horizontal, vertical and the like are used for ease in explanation, and do not denote a required orientation in use.

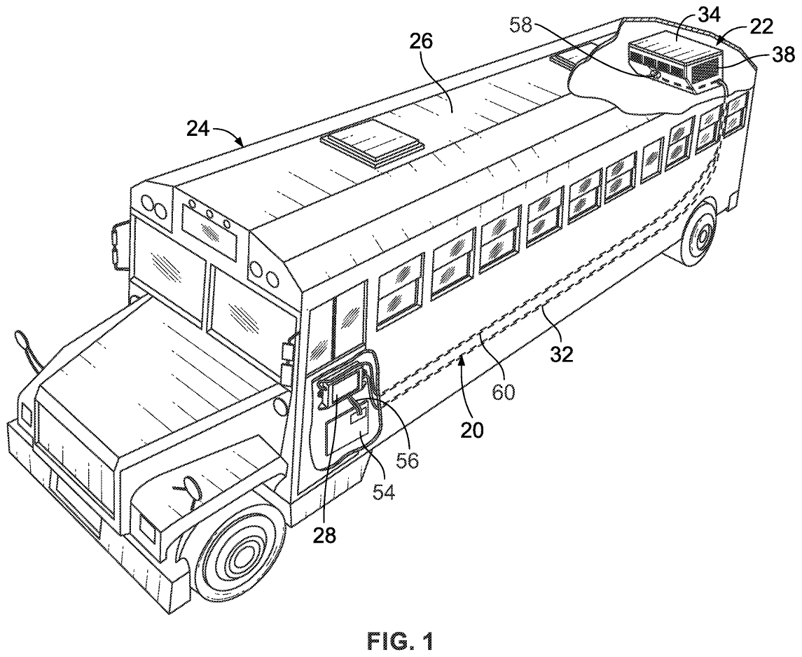

As shown in FIGS. 1-3, an air ionization system 20 is provided for partial mounting within an air distribution unit 22 of a mobile transit vehicle 24 and partial mounting on a body 26 of the transit vehicle 24. The transit vehicle 24 is shown as a school bus in FIG. 1, however, the transit vehicle 24 is any vehicle capable of transporting persons or items from one location to another, such as, for example but not limited to, commercial bus, taxi, recreational vehicle, train, ambulance, camper, fire truck, boat, yacht, personal vehicle, airplane, construction equipment, semitrailer. The air distribution unit 22 is mounted within the body 26 of the transit vehicle 24 and circulates air within an interior of the body 26. The air ionization system 20 includes a block 28, in which electronic control circuitry is housed, mounted on the body 26 of the transit vehicle 24, and a pair of air ionizing electrodes 30a, 30b remotely mounted from the block 28 and within the air distribution unit 22, but connected to the electronic control circuitry within the block 28 by wiring 32. In some embodiments, the transit vehicle 24 is moved along the roads via wheels.

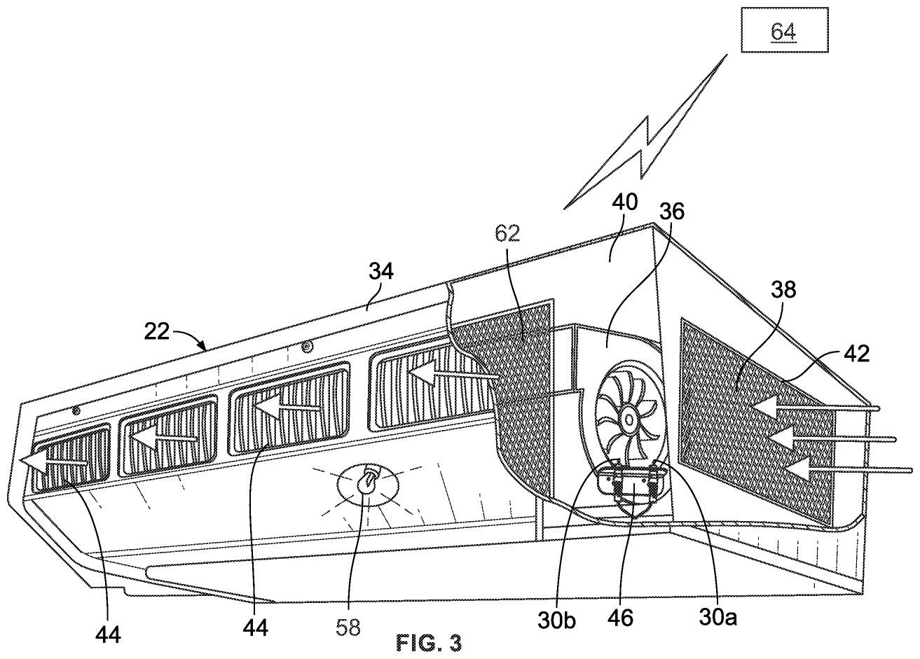

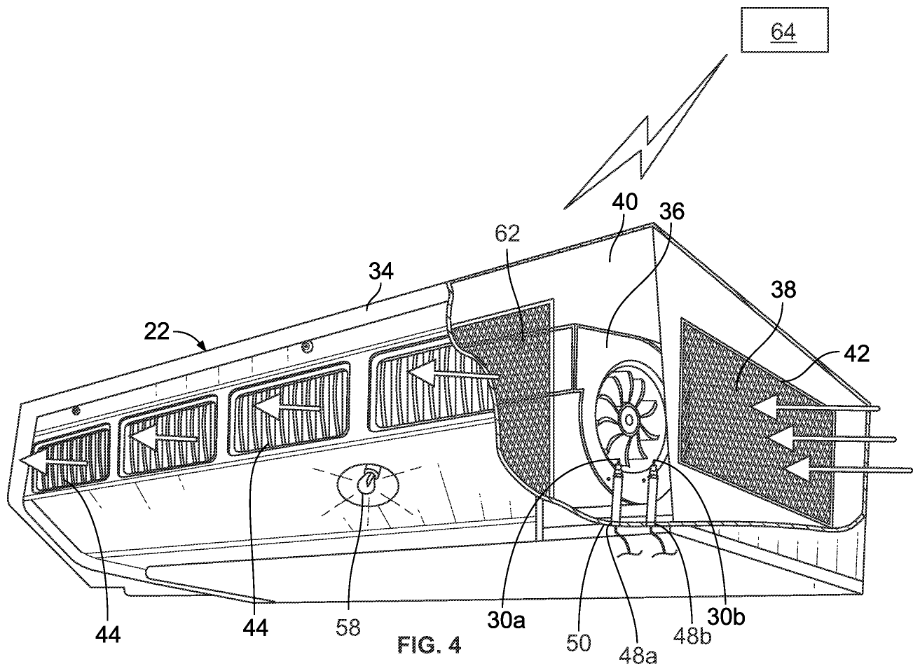

As best shown in FIGS. 3 and 4, the air distribution unit 22 includes a housing 34, which may be a duct or a conduit, in which a fan or blower 36 and a filter 38 are mounted within a cavity 40 of the housing 34. The housing 34 has an inlet opening 42 in which the filter 38 is positioned, and at least one outlet opening 44 at the output of the fan or blower 36. Air from exterior to the housing 34 is pulled through the inlet opening 42, through the filter 38, into the cavity 40, and then into the fan or blower 36. The outlet opening(s) 44 may also have a filter positioned therein. Air is expelled from the housing 34 through the outlet opening(s) 44 by the fan or blower 36. The filter 38 may be a mesh media, a screen media, paper media, cloth media, or other filter media.

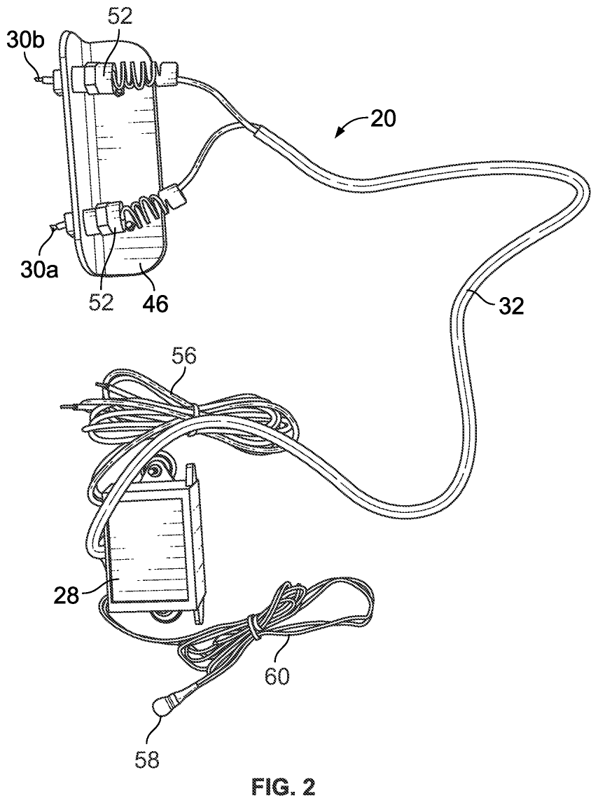

In a first embodiment as shown in FIGS. 2 and 3, the air ionizing electrodes 30a, 30b are mounted in spaced apart positions on a bracket 46 which is either integrally formed with the fan or blower 36 or attached to the fan or blower 36. Alternatively, the bracket 46 may be either integrally formed with the housing 34 or attached to the housing 34 directly proximate to the inlet of the fan or blower 36. The bracket 46 is mounted at the inlet of the fan or blower 36 and downstream of the filter 38. The air ionizing electrodes 30a, 30b are aligned generally perpendicularly to the direction of the airflow generated by the fan or blower 36. One or more sets of air ionizing electrodes 30a, 30b can be provided. The air ionizing electrodes 30a, 30b are positioned directly within the air stream being generated by the fan or blower 36 and may extend through apertures in the bracket 46. The bracket 46 may be attached by fasteners, magnets, adhesive, or any other means which provide for a permanent affixation of the bracket 46 after mounting.

In a second embodiment as shown in FIG. 4, the bracket 46 is eliminated and the air ionizing electrodes 30a, 30b are mounted in spaced apart positions through apertures 48a, 48b in a wall 50 of the housing 34. While the wall 50 is shown as the bottom wall of the housing 34, the spaced apart apertures can be provided through any wall which forms the housing 34. The apertures 48a, 48b are provided proximate to the inlet of the fan or blower 36 and downstream of the filter 38. The air ionizing electrodes 30a, 30b are positioned directly within the air stream being generated by the fan or blower 36 and are aligned generally perpendicularly to the direction of the airflow generated by the fan or blower 36. One or more sets of air ionizing electrodes 30a, 30b can be provided.

In an embodiment, the air ionizing electrodes 30a, 30b are spaced a distance of at least 2.5 inches to 2.75 inches apart.

The block 28 housing the electronic control circuitry is positioned on the body 26 of the transit vehicle 24 at a distance from the air ionizing electrodes 30a, 30b. Because the block 28 is not installed within the housing 34, the space for the block 28 is not needed and the air ionizing electrodes 30a, 30b can be easily installed in a small space. The wiring 32 is routed through the body 26 for connection between the air ionizing electrodes 30a, 30b and the block 28. Strain reliefs 52 may be provide on the wiring 32. The block 28 is powered by a power source 54 coupled thereto by wiring 56 such that the power source 54 is remote from the block 28. The block 28 can be positioned at any suitable location on the transit vehicle 24. As shown, the block 28 is positioned at the front of the transit vehicle 24 and the air ionizing electrodes 30a, 30b are positioned within the housing 34 at the back of the transit vehicle 24.

A filtered airflow downstream of the filter 38 is treated by the discharge of bipolar ionization from the air ionizing electrodes 30a, 30b to form an ionized airflow. The bipolar ionization comprises a stream of negatively charged (—) ions, and a stream of positively charged (+) ions. The ionized airflow enters the inlet of the fan or blower 36 for delivery to the treated air space through the outlet opening(s) 44 of the housing 34.

The air ionization system 20 is inaccessible to the operator and the passengers of the transit vehicle 24. The air ionization system 20 powers on and off in conjunction with the powering of the air distribution unit 22 of the transit vehicle 24.

The air ionizing electrodes 30a, 30b can be of any length to provide pinpoint Ionization into hard to access duct work.

The air ionization system 20 significantly reduces airborne contaminants such as, pathogens, allergens, odors, VOCs, and particulate matter. Independent laboratory testing of needlepoint ionization devices has shown successful reduction of airborne pathogens up to 99.7%, with a 90% reduction of SARS-CoV-2. By reducing airborne contaminants, the overall health and wellness of the transit vehicle 24 and its occupants/items is greatly improved.

Each block 28 is powered, for example by a 5-32 VDC input power source 54 and can be powered by the air distribution unit 22. In an example, the block 28 has dimensions of 3.25″×1.94″×2.38″.

A light emitting diode 58 is coupled to the electronic control circuitry of the block 28 by wiring 60 and is powered on when the block 28 is powered. The light emitting diode 58 may be remote from the block 28 and can be positioned at any desired location on the body 26 or the housing 34 and is visible to occupants of the transit vehicle 24 to let the occupants of the transit vehicle 24 that the air ionization system 20 is in use. As shown in FIG. 3, the light emitting diode 58 is positioned on the housing 34.

In an embodiment, a powered sensor 62 is mounted downstream of the fan or blower 36 and senses the properties of the ionized airflow. As shown, the sensor 62 is mounted within the cavity 40 of the housing 34 downstream of the fan or blower 36 and upstream of the outlet opening(s) 44. In an embodiment, information from the sensor 62 is transmitted to a powered base unit 64 for display of the properties to an operator of the transit vehicle 24 or to an operator which is remote from the transit vehicle 24. In an embodiment, the information is sent from the sensor 62 to the base unit 64 wirelessly. The base unit 64 may be remote from the air distribution unit 22. When the base unit 64 is used to display of the properties to an operator of the transit vehicle 24, the sensor 62 and the base unit 64 may be wirelessly coupled or may be electrically coupled by a wire. The base unit 64 may be mounted on the dashboard of the transit vehicle 24.

While particular embodiments are illustrated in and described with respect to the drawings, it is envisioned that those skilled in the art may devise various modifications without departing from the spirit and scope of the appended claims. It will therefore be appreciated that the scope of the disclosure and the appended claims is not limited to the specific embodiments illustrated in and discussed with respect to the drawings and that modifications and other embodiments are intended to be included within the scope of the disclosure and appended drawings. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the disclosure and the appended claims. Further, the foregoing descriptions describe methods that recite the performance of a number of steps. Unless stated to the contrary, one or more steps within a method may not be required, one or more steps may be performed in a different order than as described, and one or more steps may be formed substantially contemporaneously. Finally, the drawings are not necessarily drawn to scale.

I claim:

1. An air ionization system providing an ionized airflow within an air distribution unit of a transit vehicle, comprising:
a block having electronic control circuitry therein;
air ionizing electrodes; and
wiring electrically coupling the air ionizing electrodes to the electronic control circuitry within the block to position the air ionizing electrodes remote from the block.

2. The air ionization system of claim 1, further comprising a power source electrically coupled to the electronic control circuitry for powering the block.

3. The air ionization system of claim 2, wherein the power source is remote from the block and remote from the air ionizing electrodes.

4. The air ionization system of claim 2, wherein the power source is a 5-32 VDC input power source.

5. The air ionization system of claim 2, further comprising a light emitting diode electrically coupled to the electronic control circuitry, wherein the light emitting diode is powered on when the block is powered.

6. The air ionization system of claim 1, further comprising a bracket on which the air ionizing electrodes are mounted.

7. The air ionization system of claim 1, further comprising a sensor configured to sense properties of the ionized airflow; and a base unit configured to display the properties to an operator.

8. An assembly providing an ionized airflow within a transit vehicle, comprising:
an air distribution unit including:
a housing having an inlet opening and at least one outlet opening,
a fan or blower within the housing mounted between the inlet opening and the least one outlet opening, and
a filter within the housing mounted between the inlet opening and the fan or blower; and
an air ionization system including:
a block having electronic control circuitry therein,
air ionizing electrodes, and
wiring electrically coupling the air ionizing electrodes to the electronic control circuitry within the block; and
wherein the air ionizing electrodes are within the housing and positioned between the filter and an inlet of the fan or blower, and
wherein the block is remote from the air distribution unit.

9. The assembly of claim 8, further comprising a power source electrically coupled to the electronic control circuitry for powering the block.

10. The assembly of claim 9, wherein the power source is remote from the block and remote from the air distribution unit.

11. The assembly of claim 9, wherein the power source is a 5-32 VDC input power source.

12. The assembly of claim 9, further comprising a light emitting diode electrically coupled to the electronic control circuitry, wherein the light emitting diode is powered on when the block is powered.

13. The assembly of claim 12, wherein the light emitting diode is mounted on the housing and can be viewed.

14. The assembly of claim 8, wherein the filter is a mesh media, a screen media, paper media, cloth media, or other filter media.

15. The assembly of claim 8, wherein the air ionizing electrodes are aligned generally perpendicularly to a direction of airflow generated by the fan or blower.

16. The assembly of claim 8, further comprising a bracket on which the air ionizing electrodes are mounted, and the bracket is attached to one of the housing and the fan or blower.

17. The assembly of claim 8, further comprising a bracket on which the air ionizing electrodes are mounted, and the bracket is integrally formed with one of the housing and the fan or blower.

18. The assembly of claim 8, further comprising:
a sensor configured to sense properties of the ionized airflow; and
a base unit configured to display the properties to an operator.

19. The assembly of claim 18, wherein the sensor is within the housing downstream of the fan or blower.

20. The assembly of claim 18, wherein the sensor is wirelessly coupled to the base unit.
